(19) United States
(12) Patent Application Publication
(10) Pub. No.: US 2024/0254291 A1
(43) Pub. Date: Aug. 1, 2024

(54) Reducing the Content of Specific Salts of Sulfonic Acid Derivatives, Sulfonamide Derivatives or Sulfonimide Derivatives in Waste Water

(71) Applicant: Covestro Deutschland AG, Leverkusen (DE)

(72) Inventors: Helmut Werner Heuer, Siegen (DE); Michael Erkelenz, Duisburg (DE); Christian Kaiser, Tönisvorst (DE)

(21) Appl. No.: 18/561,339

(22) PCT Filed: May 16, 2022
(86) PCT No.: PCT/EP2022/063135

§ 371 Date: Nov. 16, 2023

(30) Foreign Application Priority Data
May 17, 2021 (EP) 21174019.6

(51) Int. Cl. C08J 3/20; C08J 3/12; C08L 69/00

(52) U.S. Cl. CPC C08J 3/203; C08J 3/12; C08L 69/00; C08J 2369/00; C08J 2469/00; C08L 2205/025; C08L 2205/03

(57) ABSTRACT

The present invention relates to a method for reducing the amount of specific salts of sulfonic acid, sulfonamide or sulfonimide derivatives in waste waters obtained in the preparation of a polycarbonate composition containing these specific salts. The invention also relates to a use of branched polycarbonate in a polycarbonate composition for reducing the amount of specific salts of sulfonic acid, sulfonamide or sulfonimide derivatives in waste waters obtained in the preparation of this polycarbonate composition containing these specific salts.

### CROSS-REFERENCE TO RELATED APPLICATIONS

This application is the United States national phase of International Application No. PCT/EP2022/063135 filed May 16, 2022, and claims priority to European Patent Application No. 21174019.6 filed May 17, 2021, the disclosures of which are hereby incorporated by reference in their entireties.

### BACKGROUND

### Technical Field

The present invention relates to a method for reducing the amount of specific salts of sulfonic acid, sulfonamide or sulfonimide derivatives in waste waters obtained in the preparation of a polycarbonate composition containing these specific salts. The invention also relates to a use of branched polycarbonate in a polycarbonate composition for reducing the amount of specific salts of sulfonic acid, sulfonamide or sulfonimide derivatives in waste waters obtained in the preparation of this polycarbonate composition containing these specific salts.

### Description of Related Art

Polycarbonate compositions enjoy a broad range of possible applications. However, especially for thin-walled applications, they often additionally need to be additized with flame retardants in order to be able to satisfy the high requirements on flame retardancy properties. However, reducing the amount, or even banning, various flame retardants is a consistent focal point since, depending on the chemical nature of the flame retardants, they are already classed as “substances of very high concern” (SVHCs).

For example, under the action of heat, halogenated flame retardants can release undesired halogen radicals and resulting conversion products that are harmful to the environment. In many countries in the world, therefore, the use of such flame retardants is avoided.

A common flame retardant in polycarbonate compositions is potassium perfluorobutanesulfonate (also known as Rimar salt or C4 salt). Some PFASs (polyfluoroalkyl substances) are already considered substances of very high concern under REACH since they are very long-lived, accumulate in organisms (bioaccumulation) and can be harmful to humans. For substances of very high concern, the REACH Regulation provides for particular duties of disclosure, and there may be a registration requirement, i.e. only explicitly authorized uses may continue to be used.

The German Federal Environmental Agency, the UBA, considers it necessary, in particular considering the precautionary principle, to regulate the whole substance group since all PFASs could remain in the environment for long periods of time. Therefore, the UBA, together with other authorities in Germany, the Netherlands, Denmark, Sweden and Norway, is developing an EU-wide restriction proposal under REACH for this substance group. This compound has for a long time been used for the reproducibly good flame retardancy improvement of polycarbonate compositions. The provision of corresponding polycarbonate compositions with comparable flame retardancy but with the use of less potassium perfluorobutanesulfonate therefore constitutes a major challenge.

WO2008/060714 A2 describes that flame-retardant polycarbonate compositions with simultaneously good flow properties and good transparency can be obtained by terminating the polycarbonate used with cyanophenol end groups. Example 16 in this document shows a composition comprising 70 parts linear polycarbonate, 30 parts branched polycarbonate and 0.08 parts potassium perfluorobutanesulfonate.

WO03/050176 A1 relates to translucent flame-retardant polycarbonate compositions which, without the use of chlorinated or brominated flame retardants, nevertheless exhibit good flame retardancy and at the same time have a high transparency and a low haze. The solution proposed in that document is a composition comprising a branched polycarbonate, PTFE and, inter alia, also potassium perfluorobutanesulfonate.

Document WO2012/06292 A1 describes polycarbonate compositions having good flame retardancy at low layer thicknesses without the use of chlorinated or brominated flame retardants. To this end, the use of a linear phenyl-containing siloxane and a cyclic phenyl-containing siloxane is proposed. The degree of branching of the polycarbonates used in the examples is not explicitly indicated here.

JP2013129774A describes a composition comprising linear and branched polycarbonate and a flame retardant. The degree of branching of the polycarbonates used in the examples is not explicitly indicated here.

WO2014/018672A1 and WO2015/140971A1 also disclose polycarbonate compositions. However, here too the degree of branching of the branched polycarbonate is unclear or only a very broad range of degrees of branching is disclosed.

All of these compositions are generally prepared by melt compounding the individual constituents and then pelletizing them. The melt of the composition must be cooled down for this. This is frequently achieved through the use of water, that is to say by the direct contact of the melt with water. The process water thus obtained may as a result take up constituents of the composition such that these are present thereafter in the waste water obtained. This is undesirable for some additives since the waste water must then be worked up accordingly in order that these additives do not find their way into the environment. These additives that should not make their way into the environment include, inter alia, potassium perfluorobutanesulfonate.

Proceeding from this prior art, the problem addressed by the present invention consisted in overcoming at least one disadvantage of the prior art. In particular, the problem addressed by the present invention consisted in providing a method in which the content of alkali metal, alkaline earth metal or ammonium salts of aliphatic or aromatic sulfonic acid, sulfonamide or sulfonimide derivatives in the waste water can be reduced, where the waste water is obtained in the preparation of a composition comprising linear polycarbonate and alkali metal, alkaline earth metal or ammonium salts of aliphatic or aromatic sulfonic acid, sulfonamide or sulfonimide derivatives. The composition is intended, however, to comprise a certain amount of alkali metal, alkaline earth metal or ammonium salts of aliphatic or aromatic sulfonic acid, sulfonamide or sulfonimide derivatives in order to ensure a good flame retardancy of the resulting composition. The composition is preferably to have at least a flame retardancy corresponding to the UL94 classification of V-0 at 2.00 mm, preferably 1.5 mm. In particular, the intention is for the measures for reducing the content of alkali metal, alkaline earth metal or ammonium salts of aliphatic or aromatic sulfonic acid, sulfonamide or sulfonimide derivatives to be configured such that they can be integrated into established method procedures. Very particularly preferably, the intention is for these measures to additionally be configured such that the amount of alkali metal, alkaline earth metal or ammonium salts of aliphatic or aromatic sulfonic acid, sulfonamide or sulfonimide derivatives actually used is utilized more effectively. This means that as much as possible of the alkali metal, alkaline earth metal or ammonium salts of aliphatic or aromatic sulfonic acid, sulfonamide or sulfonimide derivatives that are added to the compounding can also later be found again in the resulting composition. As a result of this, as little as possible of the alkali metal, alkaline earth metal or ammonium salts of aliphatic or aromatic sulfonic acid, sulfonamide or sulfonimide derivatives are lost in the process water/waste water.

### SUMMARY

At least one and preferably all of the abovementioned problems have been solved by the present invention. It has surprisingly been found that, by using a certain proportion of branched polycarbonate in the composition to be compounded, the amount of alkali metal, alkaline earth metal or ammonium salts of aliphatic or aromatic sulfonic acid, sulfonamide or sulfonimide derivatives in the waste water obtained in the preparation of the composition can be reduced. This makes it possible, firstly, to obtain waste waters that require less workup/are less contaminated. The method according to the invention is therefore much more ecological and, as a result of fewer workup steps, also more economical. A similar situation applies to the use according to the invention. This has the additional result that the amount of alkali metal, alkaline earth metal or ammonium salts of aliphatic or aromatic sulfonic acid, sulfonamide or sulfonimide derivatives used is utilized much more effectively. This means that the majority of the alkali metal, alkaline earth metal or ammonium salts of aliphatic or aromatic sulfonic acid, sulfonamide or sulfonimide derivatives that are used in the compounding of the constituents, comprising linear and branched polycarbonate, is also present later in the resulting composition. Little of the alkali metal, alkaline earth metal or ammonium salts of aliphatic or aromatic sulfonic acid, sulfonamide or sulfonimide derivatives are thus lost in the process water/waste water. This also makes the method according to the invention and the composition according to the invention more economical. The method according to the invention can moreover be integrated easily into already existing method procedures/existing plants, since it is necessary only to add a further component to the compounding (and adapt the amount of the linear polycarbonate correspondingly). At the same time, it has been found that the addition of a certain amount of branched polycarbonate to the composition comprising linear polycarbonate and alkali metal, alkaline earth metal or ammonium salts of aliphatic or aromatic sulfonic acid, sulfonamide or sulfonimide derivatives has the result of affording a composition that corresponds at least to a UL94 classification of V-0 at 1.5 mm. This was observed even for low amounts of alkali metal, alkaline earth metal or ammonium salts of aliphatic or aromatic sulfonic acid, sulfonamide or sulfonimide derivatives in the composition, such as for example 0.040% to 0.095% by weight based on the overall composition. Therefore, according to the invention a composition can also be prepared that reduces the amount of a compound that is present on the ECHA's REACH SVHC list. It is surprising in particular here that it is possible in the resulting composition to even possibly dispense with further additives for the polycarbonate composition, which are frequently used to achieve high flame retardancy at thin layer thicknesses. Inter alia, the composition, even without PTFE, without a halogenated flame retardant and/or also without a polysiloxane-polycarbonate block co-condensate, preferably has at least a UL94 classification of V-O at a layer thickness of at least 2.0, preferably 1.5 mm. Preferably, a slight flow improvement of the polymer melt with otherwise virtually identical property values can at the same time also be observed.

The invention provides a method for reducing the content of a component (C), selected from the group of alkali metal, alkaline earth metal or ammonium salts of aliphatic or aromatic sulfonic acid, sulfonamide or sulfonimide derivatives and combinations thereof, in the waste water obtained in the preparation of a composition, wherein the composition comprises
(A) linear polycarbonate and
(C) a compound selected from the group of alkali metal, alkaline earth metal or ammonium salts of aliphatic or aromatic sulfonic acid, sulfonamide or sulfonimide derivatives and combinations thereof, preferably potassium perfluoro-1-butanesulfonate and/or potassium diphenylsulfone sulfonate, particularly preferably potassium perfluoro-1-butanesulfonate, characterized in that the composition additionally comprises
(B) a polycarbonate having a degree of branching of 0.8 to 1.5 mol %. As already described above, it has been found that the addition of component (B) leads to a reduction of the content of component (C) in the waste water.

Preferably, a method is provided for reducing the content of a component (C), selected from the group of alkali metal, alkaline earth metal or ammonium salts of aliphatic or aromatic sulfonic acid, sulfonamide or sulfonimide derivatives and combinations thereof, in the waste water obtained in the preparation of a composition, wherein the composition comprises
(A) linear polycarbonate,
(C) a compound selected from the group of alkali metal, alkaline earth metal or ammonium salts of aliphatic or aromatic sulfonic acid, sulfonamide or sulfonimide derivatives and combinations thereof, potassium perfluoro-1-butanesulfonate and/or potassium diphenylsulfone sulfonate, particularly preferably potassium perfluoro-1-butanesulfonate and
(E) a cyclic siloxane of formula (R¹₂SiO)_{y} and/or a siloxane comprising a trifunctional siloxane unit of formula R²SiO_{3/2},
   in which each R¹ independently is a monovalent aliphatic or aromatic hydrocarbon group or a fluorinated hydrocarbon group having in each case 1 to 18 carbon atoms and y is a number from 3 to 12 and
   in which each R² independently is hydrogen, a monovalent aliphatic or aromatic hydrocarbon group having in each case 1 to 18 carbon atoms or a monovalent alkoxy group having 1 to 18 carbon atoms,
characterized in that the composition additionally comprises
(B) a polycarbonate having a degree of branching of 1.01 to 1.5 mol %.

According to the invention, the component (A) used is a linear polycarbonate. According to the invention, the term “linear” is used in particular for delimitation with respect to “branched” component (B). The person skilled in the art is familiar with linear polycarbonates. They are also aware that many polycarbonates that are referred to as “linear” may also contain a small proportion of branches. This results in part from the preparation process of the polycarbonate. One example of these intrinsic branches is that of so-called Fries structures, as described for melt polycarbonates in EP 1 506 249 A1. According to the invention, the term “linear” preferably means that the polycarbonate has a degree of branching of ≤0.4 mol %. The degree of branching is defined here as specified below with respect to component (B).

Component (A) is preferably an aromatic polycarbonate. In the context according to the invention, the term “polycarbonate” is understood to mean both homopolycarbonates and copolycarbonates. According to the invention, it is also possible to use mixtures of polycarbonates, but with each of the individual components then being linear.

It is preferable according to the invention for the compositions that are obtained by the method according to the invention to contain 4% to 85% by weight of component (A), preferably 5% to 82% by weight, particularly preferably 15% to 81% by weight, especially preferably 20% to 80% by weight. A proportion of component (A) of 4% to 85% by weight, or of the above-described preferred % by weight, of the overall composition, means according to the invention that the composition is based on polycarbonate.

The linear polycarbonates present in the compositions are prepared in a known manner from dihydroxyaryl compounds, carbonic acid derivatives, and optionally chain terminators and branching agents.

Details of the preparation of polycarbonates have been set out in many patent specifications over the past 40 years or so. Reference may be made here by way of example to Schnell, “Chemistry and Physics of Polycarbonates”, Polymer Reviews, Volume 9, Interscience Publishers, New York, London, Sydney 1964, to D. Freitag. U. Grigo, P. R. Müller, H. Nouvertné, BAYER AG, “Polycarbonates” in Encyclopedia of Polymer Science and Engineering, Volume 11, Second Edition, 1988, pages 648-718 and finally to U. Grigo, K. Kirchner and P. R. Müller “Polycarbonate” [Polycarbonates] in Becker/Braun, Kunststoff-Handbuch [Plastics Handbook], volume 3/1, Polycarbonate, Polyacetale, Polyester, Celluloseester [Polycarbonates, Polyacetals, Polyesters, Cellulose Esters], Carl Hanser Verlag Munich, Vienna 1992, pages 117 to 299.

Polycarbonates are prepared, for example, by reaction of dihydroxyaryl compounds with carbonyl halides, preferably phosgene, and/or with aromatic dicarbonyl dihalides, preferably benzenedicarbonyl dihalides, by the interfacial process, optionally with use of chain terminators and optionally with use of trifunctional or more than trifunctional branching agents. Likewise possible is preparation via a melt polymerization method, by reacting dihydroxyaryl compounds with, for example, diphenyl carbonate.

Dihydroxyaryl compounds suitable for the preparation of polycarbonates are for example resorcinol, dihydroxydiphenyls, bis(hydroxyphenyl)alkanes, bis(hydroxyphenyl)cycloalkanes, bis(hydroxyphenyl) sulfides, bis(hydroxyphenyl) ethers, bis(hydroxyphenyl) ketones, bis(hydroxyphenyl) sulfones, bis(hydroxyphenyl) sulfoxides, α,α′-bis(hydroxyphenyl)diisopropylbenzenes, phthalimidines derived from derivatives of isatin or phenolphthalein, and the ring-alkylated and ring-arylated compounds thereof.

Preferred dihydroxyaryl compounds are 4,4′-dihydroxydiphenyl, 2,2-bis(4-hydroxyphenyl)propane (bisphenol A), 2,4-bis(4-hydroxyphenyl)-2-methylbutane, 1,1-bis(4-hydroxyphenyl)-p-diisopropylbenzene, 2,2-bis(3-methyl-4-hydroxyphenyl)propane, dimethylbisphenol A, bis(3,5-dimethyl-4-hydroxyphenyl)methane, 2,2-bis(3,5-dimethyl-4-hydroxyphenyl)propane, bis(3,5-dimethyl-4-hydroxyphenyl) sulfone, 2,4-bis(3,5-dimethyl-4-hydroxyphenyl)-2-methylbutane, 1,1-bis(3,5-dimethyl-4-hydroxyphenyl)-p-diisopropylbenzene and 1,1-bis(4-hydroxyphenyl)-3,3,5-trimethylcyclohexane and also the bisphenols (Aa) to (Ca)

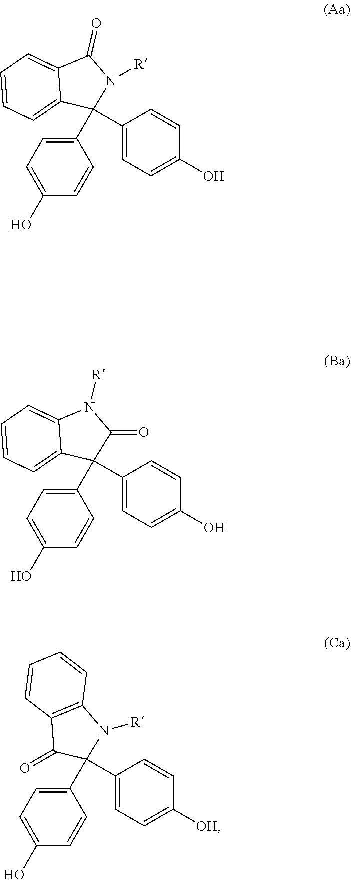

in which each R′ is C1- to C4-alkyl, aralkyl or aryl, preferably methyl or phenyl, very particularly preferably methyl.

Particularly preferred bisphenols are 2,2-bis(4-hydroxyphenyl)propane (bisphenol A), 2,2-bis(3,5-dimethyl-4-hydroxyphenyl)propane, 1,1-bis(4-hydroxyphenyl)cyclohexane, 1,1-bis(4-hydroxyphenyl)-3,3,5-trimethylcyclohexane, 4,4′-dihydroxydiphenyl and dimethylbisphenol A, and also the bisphenols of formulae (Aa), (Ba) and (Ca). Very particular preference is given to bisphenol A.

These and other suitable dihydroxyaryl compounds are described by way of example in U.S. Pat. Nos. 3,028,635 A, 2,999,825 A, 3,148,172 A, 2,991,273 A, 3,271,367 A, 4,982,014 A and 2,999,846 A, in DE 1 570 703 A, DE 2063 050 A, DE 2 036 052 A, DE 2 211 956 A and DE 3 832 396 A, in FR 1 561 518 A, in the monograph “H. Schnell, Chemistry and Physics of Polycarbonates, Interscience Publishers, New York 1964” and also in JP 62039/1986 A, JP 62040/1986 A and JP 105550/1986 A.

In the case of homopolycarbonates only one dihydroxyaryl compound is used; in the case of copolycarbonates two or more dihydroxyaryl compounds are used.

Examples of suitable carbonic acid derivatives are phosgene or diphenyl carbonate.

Suitable chain terminators that may be used in the preparation of the polycarbonates are monophenols. Examples of suitable monophenols include phenol itself, alkylphenols such as cresols, p-tert-butylphenol, cumylphenol, and also mixtures thereof. However, preferably no cyanophenol is used as chain terminator.

It is furthermore preferable according to the invention for the linear polycarbonate (A) and/or optionally also the polycarbonate (B) described further below to comprise end groups of formulae (2a), (2b) and/or (2c):

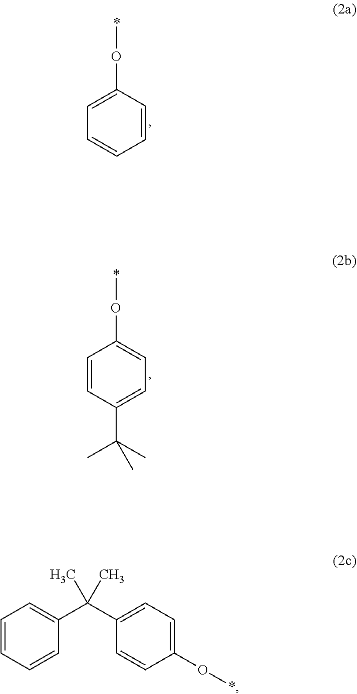

where * represents the position at which formulae (2a), (2b) and (2c) terminate the respective polycarbonate (A) and/or (B). It is furthermore preferable for the linear polycarbonate (A) to have end groups of formulae (2a) and/or (2b), especially preferably of formula (2a).

The amount of chain terminator to be used is preferably 0.1 to 5 mol %, based on moles of dihydroxyaryl compounds used in each case. The chain terminators may be added before, during or after the reaction with a carbonic acid derivative.

Particularly preferred polycarbonates (A) are the homopolycarbonate based on bisphenol A, the copolycarbonates based on 1,1-bis(4-hydroxyphenyl)-3,3,5-trimethylcyclohexane and 4,4′-dihydroxydiphenyl and also the copolycarbonates based on the two monomers bisphenol A and 1,1-bis(4-hydroxyphenyl)-3,3,5-trimethylcyclohexane, and also homo- or copolycarbonates derived from the dihydroxyaryl compounds of formulae (Ia), (IIa) and (IIIa), especially with bisphenol A.

The polycarbonates (A) preferably have weight-average molecular weights Mw of 15 000 g/mol to 40 000 g/mol, more preferably to 34 000 g/mol, particularly preferably of 17 000 g/mol to 33 000 g/mol, in particular of 19 000 g/mol to 32 000 g/mol, determined by gel permeation chromatography, calibrated against bisphenol A polycarbonate standards using dichloromethane as eluent, calibration with linear polycarbonates (formed from bisphenol A and phosgene) of known molar mass distribution from PSS Polymer Standards Service GmbH, Germany, and calibration by method 2301-0257502-09D (2009 German-language edition) from Currenta GmbH & Co. OHG, Leverkusen. The eluent is dichloromethane. Column combination of crosslinked styrene-divinylbenzene resins. Diameter of analytical columns: 7.5 mm; length: 300 mm. Particle sizes of column material: 3 μm to 20 μm. Concentration of solutions: 0.2% by weight. Flow rate: 1.0 ml/min, temperature of solutions: 30° C. Use of UV and/or RI detection.

The melt volume flow rate (MVR), determined to ISO 1133-1:2012-03 at 300° C. with 1.2 kg load, is 3 to 40 cm³/(10 min), preferably 4 to 35 cm³/(10 min).

For incorporation of possible additives, component (A) is preferably used in the form of powders, pellets or mixtures of powders and pellets.

Furthermore used according to the invention as component (B) is a polycarbonate having a degree of branching of 0.8 to 1.5 mol %.

According to the invention, it has been found that the use of component (B) enables a reduction of the amount of component (C) in the waste water, but also in the overall composition. The resulting shaped bodies of the composition nevertheless exhibit good flame retardancy, i.e. at least a flame retardancy according to the UL94 classification of V-0 at 2.00 mm, preferably at 1.5 mm.

It is especially preferable for the linear polycarbonate (A) and the branched polycarbonate (B) to have end groups of formulae (2a) and/or (2b). Very particularly preferably, the linear polycarbonate (A) has end groups of formula (2a) and the branched polycarbonate (B) has end groups of formula (2b).

According to the invention, reference is also made in the case of component (B) or polycarbonate (B) to branched polycarbonate. This has a degree of branching of 0.8 to 1.5 mol %, preferably 0.9 to 1.3 mol %, very particularly preferably of 1.00 to 1.25 mol %, particularly preferably of 1.1 to 1.2 mol %. It is likewise preferable for component (B) or polycarbonate (B) to have a degree of branching according to the invention of 1.01 to 1.5 mol %, especially preferably of 1.02 to 1.3 mol %, particularly preferably of 1.03 to 1.25 mol %, more particularly preferably of 1.04 to 1.20 mol %, more preferably of 1.05 to 1.15 mol %, more preferably of 1.06 to 1.13 mol %, and very particularly preferably of 1.07 to 1.1 mol %. According to the present invention, the term “branched” is to be understood as meaning that the polycarbonate has a plurality of branching points, or a degree of branching. This degree of branching is reported in mol % and is calculated according to the following formula:

$$mol \% ( degree of branching ) = mol ( branching agent ) \text{} / ( mol ( branching agent ) + ( mol ( dihydroxy compound ) ) \cdot 100$$

where the “branching agent” is the branching agent which comprises at least 3 functional groups and the “dihydroxy compound” is the compound having only 2 functional groups and used for preparation of the polycarbonate. In the examples, for example, the branching agent used is THPE and the dihydroxy compound is BPA. The following then results:

$$mol \% ( degree of branching ) = ( m ( THPE ) [ g ] / M ( THPE ) [ g / mol ] ) / ( ( m [ THPE ) [ g ] / M ( THPE ) [ g / mol ] ) + ( m ( BPA ) [ g ] / M ( BPA ) [ g / mol ] ) ) \cdot 100$$

where M(THPE)=306 g/mol and M(BPA)=228 g/mol and m(THPE) and m(BPA) are the mass of the corresponding reactants in the preparation of the branched polycarbonate.

Although the mol % of the degree of branching is calculated on the basis of the reactants used, the term “degree of branching” relates, according to the invention, to the chemical structure of the branching agent as present in the polycarbonate after the reaction. It is preferable here for the polycarbonate (B) to have branches selected from the group consisting of formulae (IIa) to (IIf) and any desired mixtures thereof:

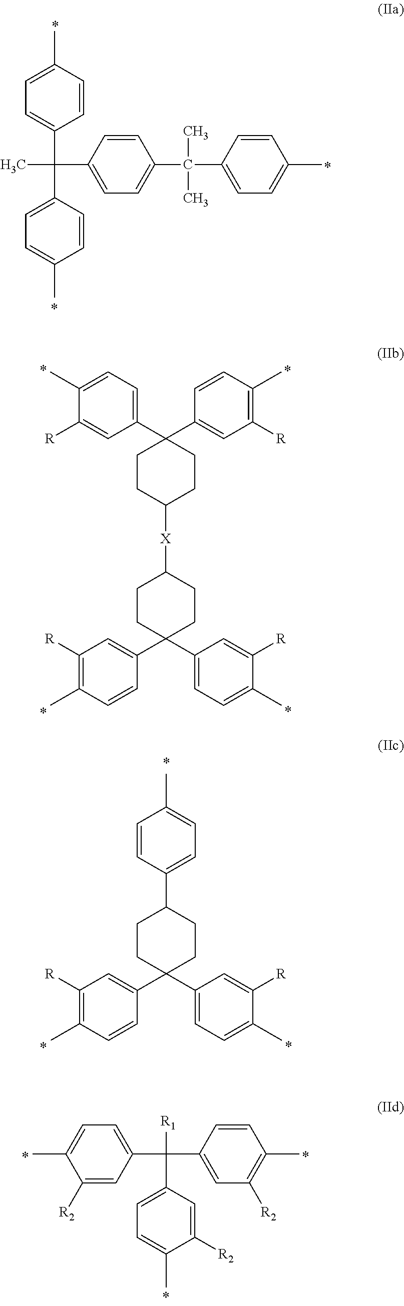

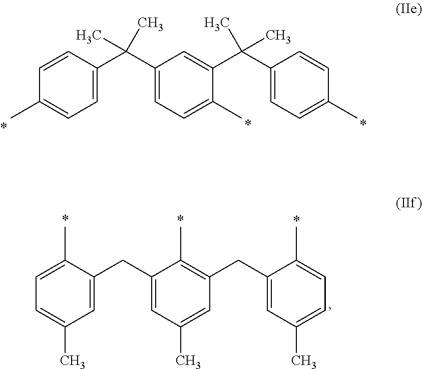

where * represents the positions which connect the branches to the polycarbonate chain
and
each R independently is H and an alkyl, preferably H and methyl,
X is a linear or branched alkyl or a single bond, preferably C(CH₃)₂ or a single bond,
each R₁ independently is H and an alkyl, preferably H and methyl and
each R₂ independently is H and an alkyl, preferably H and methyl.

The branched polycarbonate (B) may have one type of the branches shown above or a mixture of two or more branches. In a preferred embodiment, the polycarbonate (B) has branches of formula (IId). It is especially preferable here for R₁ and R₂ to independently be H or alkyl. Particularly preferably, R₁ is methyl and R₂ is H. Such a branching structure results when THPE is used as branching agent.

The polycarbonate (B) may preferably be prepared by the routes described above with respect to polycarbonate (A). However, in this case the polycarbonate (B) is preferably prepared by the interfacial process. This makes it possible to exactly set the degree of branching.

Dihydroxyaryl compounds suitable for the preparation of polycarbonates (B) are for example resorcinol, dihydroxydiphenyls, bis(hydroxyphenyl)alkanes, bis(hydroxyphenyl)cycloalkanes, bis(hydroxyphenyl) sulfides, bis(hydroxyphenyl) ethers, bis(hydroxyphenyl) ketones, bis(hydroxyphenyl) sulfones, bis(hydroxyphenyl) sulfoxides, α,α′-bis(hydroxyphenyl)diisopropylbenzenes, phthalimidines derived from derivatives of isatin or phenolphthalein, and the ring-alkylated and ring-arylated compounds thereof.

Preferred dihydroxyaryl compounds are 4,4′-dihydroxydiphenyl, 2,2-bis(4-hydroxyphenyl)propane (bisphenol A), 2,4-bis(4-hydroxyphenyl)-2-methylbutane, 1,1-bis(4-hydroxyphenyl)-p-diisopropylbenzene, 2,2-bis(3-methyl-4-hydroxyphenyl)propane, dimethylbisphenol A, bis(3,5-dimethyl-4-hydroxyphenyl)methane, 2,2-bis(3,5-dimethyl-4-hydroxyphenyl)propane, bis(3,5-dimethyl-4-hydroxyphenyl) sulfone, 2,4-bis(3,5-dimethyl-4-hydroxyphenyl)-2-methylbutane, 1,1-bis(3,5-dimethyl-4-hydroxyphenyl)-p-diisopropylbenzene and 1,1-bis(4-hydroxyphenyl)-3,3,5-trimethylcyclohexane and also the bisphenols (Aa) to (Ca)

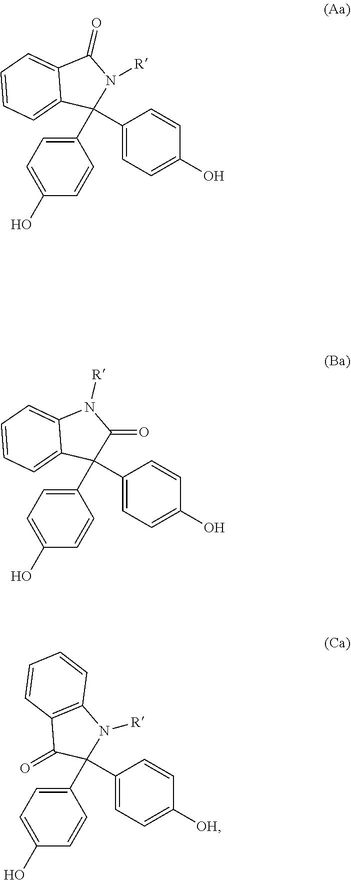

in which each R′ is C1- to C4-alkyl, aralkyl or aryl, preferably methyl or phenyl, very particularly preferably methyl.

Particularly preferred bisphenols are 2,2-bis(4-hydroxyphenyl)propane (bisphenol A), 2,2-bis(3,5-dimethyl-4-hydroxyphenyl)propane, 1,1-bis(4-hydroxyphenyl)cyclohexane, 1,1-bis(4-hydroxyphenyl)-3,3,5-trimethylcyclohexane, 4,4′-dihydroxydiphenyl and dimethylbisphenol A, and also the bisphenols of formulae (Aa), (Ba) and (Ca). Very particular preference is given to bisphenol A.

As already described above, branching agents are used in the synthesis of the polycarbonate (B) in order to obtain the corresponding degree of branching. Suitable branching agents are the trifunctional or more than trifunctional compounds known in polycarbonate chemistry, in particular those having three or more than three phenolic OH groups.

Examples of suitable branching agents are 1,3,5-tri(4-hydroxyphenyl)benzene, 1,1,1-tri(4-hydroxyphenyl)ethane, tri(4-hydroxyphenyl)phenylmethane, 2,4-bis(4-hydroxyphenylisopropyl)phenol, 2,6-bis(2-hydroxy-5′-methylbenzyl)-4-methylphenol, 2-(4-hydroxyphenyl)-2-(2,4-dihydroxyphenyl)propane, tetra(4-hydroxyphenyl)methane, tetra(4-(4-hydroxyphenylisopropyl)phenoxy)methane, and 1,4-bis((4′,4″-dihydroxytriphenyl)methyl)benzene, and 3,3-bis(3-methyl-4-hydroxyphenyl)-2-oxo-2,3-dihydroindole.

Especial preference is given to branching agents of formulae (IIIa) to (IIIf):

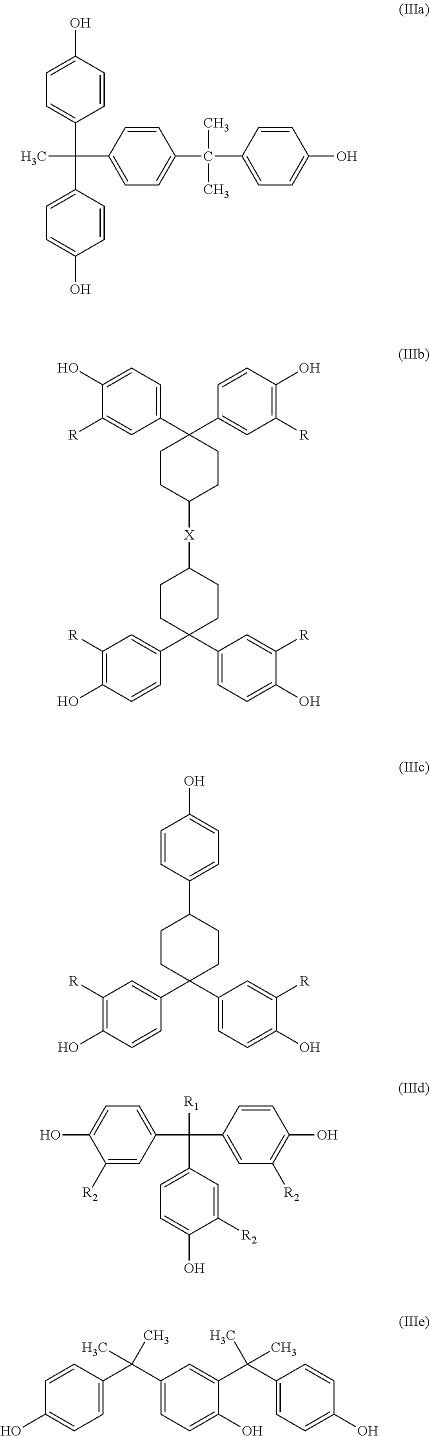

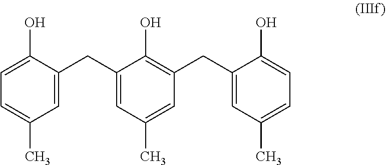 [SMILES: Cc1ccc(O)c(Cc2cc(C)cc(Cc3cc(C)ccc3O)c2O)c1]

in which
each R independently is H and an alkyl, preferably H and methyl,
X is a linear or branched alkyl or a single bond, preferably C(CHs), or a single bond,
each R₁ independently is H and an alkyl, preferably H and methyl and
each R₂ independently is H and an alkyl, preferably H and methyl.

Especial preference is given to using a branching agent of formula (IId). It is especially preferable here for R₁ and R₂ to independently be H or alkyl. Particularly preferably, R₁ is methyl and R₂ is H.

The branching agents can either form an initial charge with the dihydroxyaryl compounds and the chain terminators in the aqueous alkaline phase or can be added, dissolved in an organic solvent, before the phosgenation. In the case of the transesterification method, the branching agents are used together with the dihydroxyaryl compounds.

The polycarbonates (B) preferably have weight-average molecular weights Mw of 15 000 g/mol to 40 000 g/mol, more preferably 18 000 to 34 000 g/mol, particularly preferably of 22 000 g/mol to 33 000 g/mol, in particular of 23 000 g/mol to 32 000 g/mol, determined by gel permeation chromatography, calibrated against bisphenol A polycarbonate standards using dichloromethane as eluent, calibration with linear polycarbonates (formed from bisphenol A and phosgene) of known molar mass distribution from PSS Polymer Standards Service GmbH, Germany, and calibration by method 2301-0257502-09D (2009 German-language edition) from Currenta GmbH & Co. OHG, Leverkusen. The eluent is dichloromethane. Column combination of crosslinked styrene-divinylbenzene resins. Diameter of analytical columns: 7.5 mm; length: 300 mm. Particle sizes of column material: 3 μm to 20 μm. Concentration of solutions: 0.2% by weight. Flow rate: 1.0 ml/min, temperature of solutions: 30° C. Use of UV and/or RI detection.

The melt volume flow rate (MVR), determined to ISO 1133-1:2012-03 at 300° C. with 1.2 kg load, is 3 to 40 cm³/(10 min), preferably 4 to 35 cm³/(10 min).

It is preferable according to the invention for the compositions that are obtained by the method according to the invention to contain 14% to 95% by weight of component (B), preferably 17% to 94% by weight, particularly preferably 18% to 84% by weight, very particularly preferably 19% to 79% by weight. The person skilled in the art is aware that component (B) is more expensive than component (A). Therefore, said person will seek to optimize the ratio of (A) to (B) so that good properties (e.g. sufficient flame retardancy, good processability, etc.) result, yet for the desired applications economical compositions are nevertheless formed.

The method according to the invention and also the use according to the invention relate to the reduction of the amount of component (C) in the waste water. Here, component (C) is a compound selected from the group of alkali metal, alkaline earth metal or ammonium salts of aliphatic or aromatic sulfonic acid, sulfonamide or sulfonimide derivatives and combinations thereof.

It will be appreciated that a combination of two or more such flame retardants may also be involved. It will also be appreciated that two or more representatives from one of the compound groups mentioned may also be involved.

According to the invention, “derivatives” here and elsewhere herein are understood to mean those compounds having a molecular structure that has, in place of a hydrogen atom or a functional group, a different atom or a different group of atoms or in which one or more atoms/groups of atoms has/have been removed. The parent compound is thus still recognizable.

It is preferable in particular for the composition according to the invention to comprise, as component (C), a compound selected from the group of aliphatic or aromatic sulfonic acid derivatives. This compound particularly preferably does not comprise any lactone-modified derivatives. In particular, this compound does not comprise those derivatives as are described in KR20130124930 A.

As flame retardant, compositions according to the invention particularly preferably comprise one or more compounds selected from the group consisting of sodium or potassium perfluorobutanesulfate, sodium or potassium perfluoromethanesulfonate, sodium or potassium perfluorooctanesulfate, sodium or potassium 2,5-dichlorobenzenesulfate, sodium or potassium 2,4,5-trichlorobenzenesulfate, sodium or potassium diphenylsulfone sulfonate, sodium or potassium 2-formylbenzenesulfonate, sodium or potassium (N-benzenesulfonyl)benzenesulfonamide, partially fluorinated sodium or potassium fluoroalkylsulfonates, or mixtures thereof.

Preference is given to using sodium or potassium perfluorobutanesulfate, sodium or potassium perfluorooctanesulfate, sodium or potassium diphenylsulfone sulfonate, or mixtures thereof. Very particular preference is given to potassium perfluoro-1-butanesulfonate, which is commercially available, inter alia, as Bayowet® C4 from Lanxess, Leverkusen, Germany. Likewise used with preference is potassium diphenylsulfone sulfonate, also known as KSS (CAS 63316-43-8). Very particular preference is given to potassium perfluoro-1-butanesulfonate and/or potassium diphenylsulfone sulfonate.

The compositions that are obtained by the method according to the invention preferably contain 0.040% to 0.095% by weight, further preferably 0.045% to 0.094% by weight, further preferably 0.050% to 0.093% by weight, further preferably 0.055% to 0.092% by weight, further preferably 0.060% to 0.091% by weight, further preferably 0.065% to 0.090% by weight, further preferably 0.070% to 0.085% by weight of component (C).

It is preferable for the method according to the invention in all configurations to comprise a step in which the content of component (C) in the waste water obtained in the preparation of the described composition is measured. The content of component (C) in the waste water is preferably measured via DIN 38407-42:2011-03. This method will be elucidated in more detail again further below.

It is furthermore preferable for the value determined after the measurement of the content of component (C) to be compared to a predetermined value.

The compositions that are obtained by the method according to the invention may likewise optionally contain a reinforcing fibre as component (D). These reinforcing fibres may preferably be selected from glass fibres or carbon fibres.

The glass fibres are typically based on a glass composition selected from the group of the M, E, A, S, R, AR, ECR, D, Q and C glasses, preference being given to E, S or C glass.

The glass fibres may be used in the form of chopped glass fibres, long and also short fibres, ground fibres, glass fibre weaves or mixtures of the abovementioned forms, preference being given to the use of chopped glass fibres and ground fibres. Particular preference is given to using chopped glass fibres.

The preferred fibre length of the chopped glass fibres before compounding is 0.5 to 10 mm, more preferably 1.0 to 8 mm, very particularly preferably 1.5 to 6 mm.

Chopped glass fibres may be used with different cross sections. Preference is given to using round, elliptical, oval, figure-of-8 and flat cross sections, particular preference being given to round, oval and flat cross sections.

The diameter of the employed round fibres prior to compounding is preferably 5 to 25 μm, more preferably 6 to 20 μm, particularly preferably 7 to 17 μm, determined by means of analysis by light microscopy.

Preferred flat and oval glass fibres have a cross-sectional ratio of height to width of about 1.0:1.2 to 1.0:8.0, preferably 1.0:1.5 to 1.0:6.0, particularly preferably 1.0:2.0 to 1.0:4.0.

Preferred flat and oval glass fibres have an average fibre height of 4 μm to 17 μm, more preferably of 6 μm to 12 μm and particularly preferably 6 μm to 8 μm, and an average fibre width of 12 μm to 30 μm, more preferably 14 μm to 28 μm and particularly preferably 16 μm to 26 μm. The fibre dimensions are preferably determined by means of analysis by light microscopy.

The glass fibres are preferably modified with a glass sizing agent on the surface of the glass fibre. Preferred glass sizing agents include epoxy-modified, polyurethane-modified and unmodified silane compounds and mixtures of the aforementioned silane compounds. The glass fibres may also not have been modified with a glass sizing agent.

It is a feature of the glass fibres used that the selection of the fibre is not limited by the interaction characteristics of the fibre with the polycarbonate matrix. An improvement in the properties according to the invention of the compositions is obtained both for strong binding to the polymer matrix and in the case of a non-binding fibre.

Binding of the glass fibres to the polymer matrix is apparent in the low-temperature fracture surfaces in scanning electron micrographs, with the majority of the broken glass fibres being broken at the same height as the matrix and only individual glass fibres protruding from the matrix. In the converse case of non-binding characteristics, scanning electron micrographs show that the glass fibres protrude significantly from the matrix or have slid out completely in low-temperature fracture.

It is also possible according to the invention to use carbon fibres as reinforcing fibres. Carbon fibres are typically industrially manufactured from precursors such as polyacrylic fibres, for example, by pyrolysis (carbonization). Long fibres and short fibres can be used in the compositions according to the invention. Preference is given to using short fibres.

The length of the chopped fibres is preferably between 3 mm and 125 mm. Particular preference is given to using fibres of 3 mm to 25 mm in length.

In addition to fibres of round cross section, fibres of cubic dimension (platelet shaped) are also usable. In addition to chopped fibres, as an alternative preference is given to using ground carbon fibres. Preferred ground carbon fibres have lengths of 50 μm to 150 μm.

The carbon fibres optionally have coatings of organic sizing agents in order to enable particular modes of binding to the polymer matrix. The preferred sizing agents correspond to those mentioned for glass fibres.

Short chopped fibres and ground carbon fibres are typically added to the polymeric base materials by compounding.

For long threads, specific technical processes are typically used to arrange carbon in ultrafine threads. These filaments typically have a diameter of 3 to 10 μm. The filaments can also be used to produce rovings, wovens, nonwovens, tapes, hoses or the like.

The reinforcing fibres (D) can be present in the resulting composition at 0% to 40% by weight, preferably 1% to 35% by weight, particularly preferably 5% to 30% by weight and very particularly preferably 9% to 25% by weight.

The person skilled in the art is aware that the presence of the reinforcing fibres in the composition according to the invention influences the flame retardancy of the composition at any given melt viscosity. The person skilled in the art will consider themselves capable, should V-0 not be achieved at 2.00 mm, preferably 1.5 mm, of increasing the amount of polycarbonate (B) in the composition in particular by way of the present invention so that a corresponding flame retardancy of V-0 at 2.0 mm, preferably 1.5 mm, is obtained with the same melt viscosity. It is preferable according to the invention for compositions without a reinforcing fibre (D) to have a flame retardancy of at least V-0 at 2.0 mm. It is likewise preferable for compositions with a reinforcing fibre (D) to have a flame retardancy of at least V-0 at 1.5 mm. Likewise preferably, it is simultaneously preferable for compositions with a reinforcing fibre (D) to have a flame retardancy of at least 5VA at 3.0 mm.

The compositions that are obtained by the method according to the invention comprise components (A) to
(D) in the percentages by weight indicated, where the percentages by weight are always based in each case (unless otherwise indicated) on the sum total of components (A) to (D).

It is preferable for the composition to comprise
(A) 4% to 85% by weight of linear polycarbonate,
(B) 14% to 95% by weight of polycarbonate having a degree of branching of 0.8 to 1.5 mol %,
(C) 0.050% to 0.095% by weight of the compound selected from the group of alkali metal, alkaline earth metal or ammonium salts of aliphatic or aromatic sulfonic acid, sulfonamide or sulfonimide derivatives and combinations thereof, and
(D) 0% to 40% by weight of a reinforcing fibre,
where the % by weight are based on the sum total of components (A) to (D).

The composition preferably comprises components (A) to (D) in the following amounts:
5% to 75% by weight of (A), particularly preferably 8% to 70% by weight, very particularly preferably 9% to 65% by weight, especially preferably 45% to 66% by weight,
14% to 84% by weight of (B), particularly preferably 16% to 81% by weight, very particularly preferably 17% to 50% by weight, especially preferably 18% to 35% by weight,
0.050% to 0.095% by weight of (C), particularly preferably 0.065% to 0.093% by weight, very particularly preferably 0.075% to 0.091% by weight, and
5% to 30% by weight of (D), particularly preferably 6% to 25% by weight, particularly preferably 7% to 22% by weight, very particularly preferably 9% to 21% by weight,
where the % by weight are based on the sum total of components (A) to (D).

It is likewise preferable for the composition according to the invention to comprise components (A) to (C) in the following amounts:
4% to 85% by weight of (A), particularly preferably 6% to 83% by weight, very particularly preferably 7% to 80% by weight, especially preferably 60% to 79% by weight,
14% to 95% by weight of (B), particularly preferably 16% to 93% by weight, very particularly preferably 17% to 92% by weight, especially preferably 19% to 25% by weight,
0.050% to 0.095% by weight of (C), particularly preferably 0.065% to 0.093% by weight, very particularly preferably 0.075% to 0.091% by weight, and
where the % by weight are based on the sum total of components (A) to (C).

The percentages by weight indicated are always based for the purposes of the present invention on the resulting compositions (obtained by the method according to the invention). That means these are the compositions which are obtained after compounding and pelletizing. However, the percentages by weight essentially correspond to the respective amounts of the individual constituents metered in during the compounding. The person skilled in the art is capable, in particular also by way of the present invention, of determining the amount in which the percentages by weight need to be metered in in order that the resulting composition exhibits the stated percentages by weight.

The term “comprise” is preferably to be understood here to mean “essentially consisting of” and very particularly preferably as “consisting of”. The person skilled in the art is capable, should the composition consist of the indicated components and the % by weight not add up to 100, to convert these accordingly so that 100% by weight results.

It is further preferable according to the invention for the composition that is obtained by the method according to the invention to additionally comprise
(E) a cyclic siloxane of formula (R¹₂SiO)_{y} and/or a siloxane comprising a trifunctional siloxane unit of formula R₂SiO_{3/2},
in which each R¹ independently is a monovalent aliphatic or aromatic hydrocarbon group or a fluorinated hydrocarbon group having in each case 1 to 18 carbon atoms and y is a number from 3 to 12 and
in which each R² independently is hydrogen, a monovalent aliphatic or aromatic hydrocarbon group having in each case 1 to 18 carbon atoms or a monovalent alkoxy group having 1 to 18 carbon atoms.

If (E) is a siloxane of formula (R¹₂SiO)_{y}, it is preferable for the fluorinated hydrocarbon group that may be represented by R¹ to be selected from the group consisting of 3-fluoropropyl, 3,3,3-trifluoropropyl, 5,5,5,4,4,3,3-heptafluoropentyl, fluorophenyl, difluorophenyl and trifluorotolyl. Particularly preferably, the cyclic siloxane of formula (R¹₂SiO)_{y} is octamethylcyclotetrasiloxane, 1,2,3,4-tetramethyl-1,2,3,4-tetravinylcyclotetrasiloxane, 1,2,3,4-tetramethyl-1,2,3,4-tetraphenylcyclotetrasiloxane, octaethylcyclotetrasiloxane, octapropylcyclotetrasiloxane, octabutylcyclotetrasiloxane, decamethylcyclopentasiloxane, dodecamethylcyclohexasiloxane, tetradecamethylcycloheptasiloxane, hexadecamethylcyclooctasiloxane, eicosamethylcyclodecasiloxane, octaphenylcyclotetrasiloxane. Particular preference is given to octaphenylcyclotetrasiloxane.

If (E) is a siloxane comprising a trifunctional siloxane unit of formula R²SiO_{3/2}, it is preferable for this siloxane to comprise this formula to an extent of at least 90 mol %, particularly preferably to an extent of at least 95 mol %, and very particularly preferably to an extent of 100 mol %, based on the totality of the moles of siloxane units (M unit, D unit, T unit, Q unit). The formula R²SiO_{3/2} represents a T unit. As the person skilled in the art is aware, an M unit represents the formula R³SiO_{1/2} (in which R represents hydrogen or a monovalent organic group), D represents a bifunctional unit of the formula R²SiO (in which R is hydrogen or a monovalent organic group) and a Q unit represents a tetrafunctional siloxane unit of formula SiO₂.

This trifunctional siloxane unit of formula R²SiO_{3/2} is also known as polysilsesquioxane. In addition to the T units, it can also contain M units. The structures are known to the person skilled in the art. They may have bridging structures or cage structures.

Preferably, R² is selected from hydrogen, C₁-C₁₂ alkyl, C₁-C₁₂ alkenyl, C₁-C₁₂ alkoxy, C₁-C₁₂ acyl, C₃-C₈ cycloalkyl or phenyl. Particularly preferably, R² is selected from C₁-C₆ alkyl, C₁-C₆ alkenyl, C₁-C₆ alkoxy and phenyl. Further preferably, R² is selected from methyl, ethyl, propyl, butyl and hexyl. R² is particularly preferably methyl. Particular preference is given to polymethylsilsesquioxane and octamethylsilsesquioxane.

It is preferable for the composition according to the invention not to contain any linear siloxanes having phenyl groups. It is preferable in particular for the composition not to contain any linear siloxanes having phenyl groups as disclosed in WO2012/065292 A1. Such siloxanes are generally oils, since they are oligomers. These are firstly difficult to meter into the composition and secondly can have undesired influences on the properties of the composition.

It is preferable for (E), if present, to be used in the compositions that are obtained by the method according to the invention in amounts of 0.5% to 2.5% by weight, particularly preferably of 0.75% to 2.15% by weight, and very particularly preferably of 0.9% to 1.5% by weight.

It is also preferable for the composition that is obtained by the method according to the invention to additionally comprise
(F) at least one further additive selected from the group consisting of heat stabilizers, mould-release agents, UV absorbers, compatibilizers, antioxidants, IR absorbers, flow improvers, transesterification stabilizers, additives for laser marking, impact modifiers, light-scattering diffusion additives and colourants.

Such additives as are typically added in the case of polycarbonates are described, for example, in EP-A 0 839 623, WO-A 96/15102, EP-A 0 500 496 or “Plastics Additives Handbook”, Hans Zweifel, 5th Edition 2000, Hanser Verlag, Munich. These additives may be added individually or else in a mixture. It will be appreciated that it is only permissible to add such additives in such amounts that do not have a significant adverse impact on the effect of the invention of good flame retardancy.

Suitable heat stabilizers are preferably triphenylphosphine, tris(2,4-di-tert-butylphenyl) phosphite (Irgafos® 168), tetrakis(2,4-di-tert-butylphenyl)-[1,1-biphenyl]-4,4′-diyl bisphosphonite, octadecyl 3-(3,5-di-tert-butyl-4-hydroxyphenyl)propionate (Irganox® 1076), bis(2,4-dicumylphenyl)pentaerythritol diphosphite (Doverphos® S-9228 PC), bis(2,6-di-tert-butyl-4-methylphenyl)pentaerythritol diphosphite (ADK STAB PEP-36). They are used alone or in a mixture (e.g. Irganox® B900 (mixture of Irgafos® 168 and Irganox® 1076 in a 4:1 ratio) or Doverphos® S-9228 PC with Irganox® B900/Irganox® 1076).

Useful as mould-release agents in particular are pentaerythritol tetrastearate (PETS) and glycerol monostearate (GMS).

The UV absorbers have minimum transmittance below 400 nm and maximum transmittance above 400 nm. Ultraviolet absorbers particularly suitable for use in the composition according to the invention are benzotriazoles, triazines, benzophenones and/or arylated cyanoacrylates.

Particularly suitable ultraviolet absorbers are hydroxybenzotriazoles, such as 2-(3′,5′-bis(1,1-dimethylbenzyl)-2′-hydroxyphenyl)benzotriazole (Tinuvin® 234, BASF SE, Ludwigshafen), 2-(2′-hydroxy-5′-(tert-octyl)phenyl)benzotriazole (Tinuvin® 329, BASF SE, Ludwigshafen), bis(3-(2H-benzotriazolyl)-2-hydroxy-5-tert-octyl)methane (Tinuvin® 360, BASF SE, Ludwigshafen), 2-(4,6-diphenyl-1,3,5-triazin-2-yl)-5-(hexyloxy)phenol (Tinuvin® 1577, BASF SE, Ludwigshafen), and also benzophenones such as 2,4-dihydroxybenzophenone (Chimassorb® 22, BASF SE, Ludwigshafen) and 2-hydroxy-4-(octyloxy)benzophenone (Chimassorb® 81, BASF SE, Ludwigshafen), 2,2-bis[[(2-cyano-1-oxo-3,3-diphenyl-2-propenyl)oxy]methyl]-1,3-propanediyl ester (9CI) (Uvinul® 3030, BASF SE Ludwigshafen), 2-[2-hydroxy-4-(2-ethylhexyl)oxy]phenyl-4,6-di(4-phenyl)phenyl-1,3,5-triazine (Tinuvin® 1600, BASF SE, Ludwigshafen), tetraethyl 2,2′-(1,4-phenylenedimethylidene)bismalonate (Hostavin® B-Cap, Clariant AG) or N-(2-ethoxyphenyl)-N′-(2-ethylphenyl)ethanediamide (Tinuvin® 312, CAS no. 23949-66-8, BASF SE, Ludwigshafen).

Particularly preferred specific UV stabilizers are Tinuvin® 360, Tinuvin® 329, Tinuvin® 312, Tinuvin® 326 and/or Tinuvin® 1600, with Tinuvin® 329, Tinuvin® 326 and/or Tinuvin® 360 being very particularly preferred.

It is also possible to use mixtures of the ultraviolet absorbers mentioned.

If UV absorbers are present, the composition preferably contains ultraviolet absorbers in an amount of up to 0.8% by weight, preferably 0.05% by weight to 0.5% by weight.

Common impact modifiers, such as polyethylene waxes, for example, are known to the person skilled in the art.

Customary light-scattering diffusion additives, such as for example polyacrylates, copolyacrylates or polysilsesquioxanes, are likewise known to the person skilled in the art.

Colorants are known to the person skilled in the art. They preferably include pigments, in particular titanium dioxide, and/or organic colorants. If titanium dioxide is present in the composition, it is preferably present to an extent of up to 15% by weight, very particularly preferably to an extent of up to 3% by weight, likewise preferably to an extent of up to 2% by weight, based on the overall composition. Alternatively, the titanium dioxide may also be present at 3% to 15% by weight, preferably 7% to 15% by weight, based on the overall composition. The person skilled in the art knows that titanium dioxide can have an impact on the flame retardancy of the composition. Therefore, colours that are obtained by virtue of them containing, inter alia, titanium dioxide, are particularly challenging when it comes to achieving at least V-0 at 2.00 mm, preferably 1.50 mm.

If the composition according to the invention comprises components (E) and/or (F), then the amounts indicated are based in each case on the sum total of the components (A) to (E) and/or (F) present.

The composition according to the invention preferably comprises, and preferably consists of, components (A) to (F) in the following amounts:
5% to 75% by weight of (A), particularly preferably 8% to 70% by weight, very particularly preferably 9% to 65% by weight,
14% to 84% by weight of (B), particularly preferably 19% to 81% by weight, very particularly preferably 24% to 80% by weight,
0.050% to 0.095% by weight of (C), particularly preferably 0.065% to 0.093% by weight, very particularly preferably 0.075% to 0.091% by weight,
5% to 30% by weight of (D), particularly preferably 6% to 25% by weight, particularly preferably 7% to 22% by weight, very particularly preferably 9% to 21% by weight,
0% to 2.5% by weight of (E), particularly preferably 0.5% to 2.2% by weight of (E), very particularly preferably 0.75% to 1.5% by weight of (E), and
0% to 3% by weight of (F), particularly preferably 1% to 2.5% by weight of (F), very particularly preferably 1.3% to 2.0% by weight of (F),
where the % by weight are based on the sum total of components (A) to (F).

It is particularly preferable for the composition according to the invention to consist of components (A) to (F).

The UL94 test method and the corresponding classification are known to the person skilled in the art. In one case this is the fire performance UL94 V at 50 W, 20 mm vertical. This test method is used when ascertaining the flammability classes UL 94 V-0, V-1, V-2. The other case is described in the class UL 5V. Classification into flammability classes is performed by evaluating the afterflame and afterglow times and also burning dripping from the test specimen.

The tested test specimen thickness is classified into the grades V-0, V-1, V-2, 5VA and 5VB (vertical burn test). These represent in detail—arranged in order of degree of stringency:
V-2: extinguishing of a vertically clamped specimen within 30 seconds. Burning dripping of plastic melt allowed.
V-1: as with V-2, but burning dripping of plastic melt not allowed. Maximum 60 seconds of afterglow.
V-0: as with V-1, but flame is extinguished within 10 seconds. Maximum 30 seconds of afterglow.

Plastics that satisfy at least the classification V-2 can additionally be tested with the 500 watt flame (125 mm flame height):
5VB: Extinguishing of a vertically clamped specimen after flame application five times for five seconds in each case; no dripping allowed.
5VA: as with 5VB, additional test on a horizontally clamped sheet; neither dripping nor formation of burn holes with a diameter >1 mm are allowed.

The test bars for UL94V are pretreated as follows:
2 days/23° C./50% rel. humidity
7 days/70° C./air circulation oven
Flame height: 20 mm
Flame application time: 2×10 s

The second flame application of the sample begins immediately after the end of the first afterflame time.

The following conditions apply for the UL94 5V fire performance:
500 W, 125 mm vertical

This method is used for ascertaining the flammability classes UL 94-5VA and -5VB.

The fire performance is assessed on bars and any potential hole formation is assessed on sheets.

### Pretreatment:

2 days/23° C./50% rel. humidity.
7 days/70° C./air circulation oven

The composition that is obtained by the method according to the invention is preferably characterized in that it is free of polytetrafluoroethylene (PTFE). PTFE is known as an anti-drip agent and is often used in polycarbonate compositions in order to improve the UL94 classification. It has additionally been found, according to the invention, that the use of PTFE in the compositions that are obtained by the method according to the invention is not necessary and a UL94 classification of V-0 at 1.5 mm can nevertheless preferably be achieved. PTFE is known to the person skilled in the art. PTFE is commercially available in a variety of product qualities. These include Hostaflon® TF2021 or PTFE blends such as Blendex® B449 (about 50% by weight of PTFE and about 50% by weight of SAN [from 80% by weight of styrene and 20% by weight of acrylonitrile]) from Chemtura.

It is also preferable for the composition that is obtained by the method according to the invention to be free of halogenated flame retardants. These are also frequently added as flame retardant to polycarbonate compositions in order to improve the flame retardancy thereof. It has additionally been found, according to the invention, that the use of halogenated flame retardants in the compositions is preferably not necessary and a UL94 classification of V-0 at 1.5 mm can nevertheless be achieved. Preference is given according to the invention to dispensing with all chemical compounds that include at least one halogen atom. One of the most common halogenated flame retardants is tetrabromobisphenol A oligocarbonate (TBBOC).

It is also preferable for the composition that is obtained by the method according to the invention to be free of a polysiloxane-polycarbonate block co-condensate. Such polysiloxane-polycarbonate block co-condensates have intrinsically good flame retardancy properties and are therefore often used in polycarbonate compositions. It has additionally been found, according to the invention, that the use of polysiloxane-polycarbonate block co-condensates in the compositions is preferably not necessary and a UL94 classification of V-0 at 2.00 mm, preferably 1.5 mm, can nevertheless be achieved. Polysiloxane-polycarbonate block co-condensates are known to the person skilled in the art. These are often also referred to as SiCoPC. They generally contain siloxane blocks that undergo condensation with bisphenols to give corresponding polymers.

It is preferable according to the invention for the composition that is obtained by the method according to the invention to be free of polytetrafluoroethylene and of a halogenated flame retardant. It is also preferable for the composition that is obtained by the method according to the invention to be free of polytetrafluoroethylene and of a polysiloxane-polycarbonate block co-condensate. It is also preferable for the composition that is obtained by the method according to the invention to be free of a halogenated flame retardant and of a polysiloxane-polycarbonate block co-condensate. Very particularly preferably, the composition that is obtained by the method according to the invention is free of polytetrafluoroethylene, of a halogenated flame retardant and of a polysiloxane-polycarbonate block co-condensate.

In the method according to the invention, the composition described above in more detail is prepared. It is preferable here for the method for preparing the composition to comprise the following steps:
(a) compounding at least components (A) to (C) and
(b) pelletizing the compound obtained from step (a) in the presence of water.

It will be apparent to the person skilled in the art that in step (a) all constituents of the composition, especially components (A) to (F), where present, are compounded.

Compounding in polymer processing refers to the preparation of a finished plastics moulding compound, the compound, from optionally two or more polymeric raw materials with the optional addition of polymer additives such as for example components (C) to (F) mentioned above. The compounding is predominantly effected in kneaders or extruders and comprises the process operations of conveying, melting, dispersing, mixing, degassing and pressure build-up. According to the invention, the compound is often also referred to as composition that has been obtained by the method according to the invention.

The compounding according to the invention in step (a) preferably comprises the following steps:
(a1) optionally mixing components (A) and (B) in the form of pellets and/or powders,
(a2) introducing at least components (A) to (C), preferably at least components (A) to (F), into a compounding unit wherein, if process step (a1) has been performed, the resulting mixture from (a1) is introduced together with the other components and
(a3) supplying thermal and/or mechanical energy in the compounding unit from (a2), so that a temperature of 200° C. to 350° C., preferably 220° C. to 320° C., particularly preferably 230° C. to 300° C., is achieved, thereby melting, mixing and interdispersing at least components (A) to (C), preferably at least components (A) to (F), and then degassing the resulting mixture in the degassing zone of the compounding unit.

“Pellets” in the context of the invention are understood to mean a component or a mixture composed of a plurality of components present in the solid state of matter, the solid particles having a particle size of at least 2 mm and generally of not more than 10 mm. The pellet grains may be of any desired shape, for example lenticular shape, spherical shape or cylindrical shape. This term is also used, inter alia, for delimitation from “powders”. “Powder” or “pulverulent” in the context of the invention is understood to mean a component or a mixture composed of a plurality of components present in the solid state of matter and in which the particles have particle sizes of less than 2 mm, preferably of less than 1 mm, especially of less than 0.5 mm.

Compounding units are known to those skilled in the art. The compounding unit is preferably a twin-screw extruder, particularly preferably a twin-screw extruder having co-rotating screws, the twin-screw extruder having a length/diameter ratio of the screw shaft preferably of 32 to 44, particularly preferably of 34 to 38. It is preferable for the compounding unit to have a melting zone and a mixing zone or a combined melting and mixing zone.

The compounding of process step (a) is followed by an at least partial solidification of the compound, brought about by cooling. This is brought about by the presence of the water in process step (b). It is preferable here for in method step (b) the composition to come into contact with the water at least temporarily in the form of a melt.

The water used may in principle be any optically clear water, for example filtered river water or well water. Preference is given to using demineralized water. In general, the demineralized water used exhibits conductivities of less than 20 S/cm, preferably less than 12 μS/cm, this being determined according to DIN EN 27888 in conjunction with DIN 50930-6. Common methods and the process steps thereof, and systems for performing process step (b), are known to the person skilled in the art. It is preferable in particular for the pelletizing in method step (b) to be underwater pelletizing or strand pelletizing. These pelletizing steps differ essentially in the order of the steps of cooling and comminuting the compound. In strand pelletizing, preferably first a polymer strand (formed from the compound) is formed by the exit of the melt from a die. The die used may for example be a die plate, such as a circular-arrangement die plate. Useful as die plates are in general heated die plates such as for example those with core/edge heating, of the heating channel type or of the heat exchanger type. This die may be part of the compounding unit. This strand may either directly come into contact with water or come into contact initially only with the ambient air and then with water. The strand remains in the water for a residence time. The at least partially cooled polymer strand is then pelletized, i.e. chopped. This may be done either underwater or else in ambient air. However, preferably the polymer strand first leaves the water for this and is thus again in the ambient air. The comminution itself is generally effected by rotating blades which chop up or break up the at least partially solidified polymer strand. Pellets are obtained. In underwater pelletizing, the polymer strand (formed from the compound) likewise exits through a die in the form of a melt. The die used may for example be a die plate, such as a circular-arrangement die plate. Useful as die plates are in general heated die plates such as for example those with core/edge heating, of the heating channel type or of the heat exchanger type. Here too, the die may be part of the compounding unit. The melt is preferably pressed into a generally water-filled cutting chamber. The cutting chamber surrounds the die. The size and shape of the cutting chamber is in principle freely selectable and is guided by practical considerations such as the size of the die plate, geometry of the blades, amount of coolant that is to be transported through the cutting chamber, or polymer throughput. In contrast to strand pelletizing, the melt is comminuted here immediately after the die. This can likewise be effected by means of a rotating blade. In general, the exit from the die, followed by the comminution, are effected immediately in water (and not in the air). However, spray-misting of temperature control liquids is also possible. The comminution results in the formation of pellets that are then separated from the water. Established methods known to the person skilled in the art are suitable for this, such as for example a separator. Underwater pelletizing generally produces spherical pellets, whereas strand pelletizing produces cylindrical pellets. According to the invention, strand pelletizing is preferably used. This has the advantage that it can be performed such that no further workup step of separating water and pellets needs to be effected.

Pellets are obtained of which preferably at least one of the length, height or width has a value of at least 0.5 to 5 mm. It may be the case here that the pellets do not have a uniform shape. For example, one parameter of the height, width and length of the pellets may not be identical to the respective other two parameters of the height, width and length. The pellets very particularly preferably have a cylindrical and/or lenticular shape. However, minor deviations from the geometric shape are intended to be included by the term “pellets”. This cylindrical and/or lenticular shape is preferably characterized in that the pellets have a length of 0.5 to 5 mm, a width of 0.5 to 5 mm and a thickness of 0.5 to 5 mm. The size of the pellets can for example be influenced, in a manner known to the person skilled in the art, via the size of the dies through which the polymer melt is pressed.

Water, generally in the form of a water bath, is used for cooling in both strand pelletizing and in underwater pelletizing. This water may be at ambient temperature or else be additionally externally cooled. In any case, it has a temperature below the temperature of the polymer melt. Prior to contact with the polymer melt, the water preferably has a temperature of 10 to 90° C., particularly preferably of 25 to 85° C. As a result of contact with the melt, the temperature of the water changes in a calculable manner known to the person skilled in the art, in some cases also only locally. From this also results, for the person skilled in the art, the extent to which mixing of the water or partial replacement of the water with fresh water is needed in order to obtain reproducible pelletizing results. The pelletizing is preferably a continuous process. It is possible here for at least a portion of the water to be continuously removed from the system and fresh water to be continuously added to the system. It is likewise also possible for the cooling water to be circulated via a heat exchanger for cooling for a certain time without exchange for fresh water. Here, the term “fresh water” means water which was not in contact with the polymer melt directly beforehand. However, it may be water which had already been in contact with the polymer melt but has then been cooled back down by the surroundings and/or else which has first been worked up and then supplied to the system again. The workup may be a chemical workup for removing components in the water.

For strand pelletizing, it is preferable according to the invention for there to be a heat exchange area of 60 000 mm² to 5 000 000 mm², preferably of 70 000 mm² to 4 900 000 mm² and very particularly preferably of 80 000 mm² to 4 800 000 mm² of the strands. This characteristic number is known to those skilled in the art. It preferably results according to the formula:

$$Heat exchange area ( {mm}^{3} ) = strand diameter ( mm ) \times π \times immersion length ( mm ) \times filament number$$

The immersion length is the length with which the strands are immersed in the water as cooling liquid. The filament number defines how many strands are immersed in the water. It generally corresponds to the number of orifices in the die plate.

It is also preferable for the strand pelletizing for the contact time of the polymer melt with the water to be in the range from 1 s to 5 s, preferably 2 s to 4 s and very particularly preferably 2 s to 3 s. The contact time results from the immersion length of the filaments in the water in mm divided by the haul-off speed in mm/s.

Depending on how the bath, in which the water as cooling medium is operated, the throughflow of the water may differ. It is also possible for there to be no throughflow of the water in the spinning bath. The amount of pellets produced per unit of time must be taken into account here.

It is preferable to use a cooling water factor, in kg/l, in the strand pelletizing in the range of 0.01 kg/l min to 0.06 kg/l min, particularly preferably of 0.015 kg/l min to 0.055 kg/l min and very particularly preferably of 0.02 kg/l min to 0.05 kg/l min. The cooling water factor results from the machine throughput (kg/min)/spinning bath volume (1).

For strand pelletizing, it is particularly preferable for there to be a heat exchange area of 60 000 mm² to 5 000 000 mm², preferably of 70 000 mm² to 4 900 000 mm² and very particularly preferably of 80 000 mm² to 4 800 000 mm² of the strands, for the contact time of the polymer melt with the water to be in the range from 1 s to 5 s, preferably 2 s to 4 s and very particularly preferably 2 s to 3 s and for a cooling water factor to be used in the range of 0.01 kg/l min to 0.06 kg/l min, particularly preferably of 0.015 kg/l min to 0.055 kg/l min and very particularly preferably of 0.02 kg/l min to 0.05 kg/l min.

In the case of underwater pelletizing, the heat exchange area preferably results according to the formula:

$${Heat exchange area ( {mm}^{2} ) = pellet diameter / 2 )}^{2} ( {mm}^{2} ) \times π \times 4.$$

According to the invention, the heat exchange area for underwater pelletizing is preferably in the range from 30-50 mm², particularly preferably in the range from 35-45 mm², per grain. 40-100 exit orifices (dies) will be envisaged in this case.

The contact time (or residence time) of the polymer melt with the cooling water in the underwater pelletizing is likewise preferably defined according to the formula:

$$Conduit length ( cutting chamber to separator ) ( mm ) \times conduit cross section ( {mm}^{2} ) / cooling water flow rate ( {mm}^{3} / s ) = contact time ( s )$$

The contact time in the underwater pelletizing is preferably 2-50 s, particularly preferably 2-49 s, very particularly preferably 2-48 s.

The cooling water factor in the underwater pelletizing is preferably defined by the formula:

$$Machine throughput ( kg / min ) / circulation rate of the cooling water amount ( l / min ) = cooling water factor ( kg / l )$$

The cooling water factor in the underwater pelletizing is preferably 0.03-0.15 kg/l, particularly preferably 0.03-0.10 kg/l, very particularly preferably 0.03-0.09 kg/l.

Irrespective of whether the method is performed continuously or via a batchwise mode of operation, after method step (b) water is obtained which had been in contact with the above-described composition, preferably at least temporarily in the form of a melt. This water thus contains constituents of the composition which as a result of method step (b) have made their way into the water. They may be present in dissolved form or else in the form of a suspension (solid in water). In compositions which contain component (C), described in more detail above, the water always contains a certain proportion of this component. However, the invention has succeeded in being able to reduce the amount of (C) in the water. This is achieved by the additional use of the branched component (B). This offers the advantage, firstly, that less component (C) is lost by the method for preparing the compound. As a result, the employed amount of (C) is more effectively used, which is ecologically and also economically advantageous. However, it is also preferable for the water present in method step (b) to be obtained as waste water after performing method step (b). Therefore, the waste water thus also contains less (C). The waste water would pass into the environment and must therefore be worked up appropriately or at least diluted. As a result of the amount of (C) in the waste water being lower according to the invention, less expense needs to be invested in workup/dilution. This again has ecological and economical advantages.

According to the invention, the proportion of component (C) in the waste water can preferably be determined by means of DIN38407-42:2011-03. When using potassium perfluorobutanesulfonate as component (C) this is then determined via the free perfluorobutanoic acid (C₄HF₇O₂). The free perfluoro acid is then enriched from the unfiltered water sample by solid-phase extraction on a polymer-based weak anion exchanger. The solid phases are washed with water and solvent and the adsorbed substance is then eluted with ammonia-containing methanol. Confirmation and quantitative determination are effected by high-performance liquid chromatography-mass spectrometry (HPLC-MS/MS). This means that by determining the proportion of free acid conclusions can be drawn concerning the proportion of component (C).

Accordingly, a “reduction of the content of component (C) in the waste water obtained in the preparation of a composition” can be determined as a result of the content of (C) in the waste water without the use of component (B) in the composition being higher than the content of (C) in the waste water under the same conditions but with the sole difference that component (B) has additionally been added to the composition. It has been found according to the invention that when reducing the content of (C) in the composition the resulting content of (C) in the waste water does not decrease linearly when component (B) is present.

A further aspect of the present invention relates to the use of a polycarbonate (B) having a degree of branching of 0.8 to 1.5 mol % for reducing the content of component (C) in the waste water obtained in the preparation of a composition, wherein the composition comprises
(A) linear polycarbonate,
(B) polycarbonate having a degree of branching of 0.8 to 1.5 mol % and
(C) a compound selected from the group of alkali metal, alkaline earth metal or ammonium salts of aliphatic or aromatic sulfonic acid, sulfonamide or sulfonimide derivatives and combinations thereof, preferably potassium perfluoro-1-butanesulfonate and/or potassium diphenylsulfone sulfonate, particularly preferably potassium perfluoro-1-butanesulfonate,

With the use according to the invention, a composition is preferably prepared as has already been described above in various preferred cases. In particular, the use according to the invention is characterized in that the preparation of the composition comprises the following steps:
(a) compounding at least components (A) to (C) and
(b) pelletizing the compound obtained from step (a) in the presence of water.

Here too, these are preferably the method steps (a) and/or (b) already described in more detail above. It is preferable here for in method step (b) the composition to come into contact with the water at least temporarily in the form of a melt. Likewise or at the same time, it is preferable for water present in method step (b) to be obtained as waste water after performing method step (b). Likewise or at the same time, it is preferable for the pelletizing in method step (b) to be underwater pelletizing or strand pelletizing.

It is especially preferable in the use according to the invention for the composition to comprise
(A) 4% to 85% by weight, preferably 5% to 82% by weight, particularly preferably 15% to 81% by weight, especially preferably 20% to 80% by weight, of a linear polycarbonate, very particularly preferably 45% to 79% by weight,
(B) 14% to 95% by weight, preferably 17% to 94% by weight, particularly preferably 18% to 84% by weight, especially preferably 19% to 79% by weight, of a polycarbonate, and very particularly preferably 18% to 35% by weight, having a degree of branching of 0.8 to 1.5 mol %,
(C) 0.040% to 0.095% by weight of the compound selected from the group of alkali metal, alkaline earth metal or ammonium salts of aliphatic or aromatic sulfonic acid, sulfonamide or sulfonimide derivatives and combinations thereof, preferably potassium perfluoro-1-butanesulfonate and/or potassium diphenylsulfone sulfonate, particularly preferably potassium perfluoro-1-butanesulfonate and
(D) 0% to 40% by weight of a reinforcing fibre,
where the % by weight are based on the sum total of components (A) to (D).

### EXAMPLES

The polycarbonate-based compositions described in the following examples were prepared by compounding on a Berstorff ZE 25 extruder at a throughput of 10 kg/h. The melt temperature was 275-350° C.

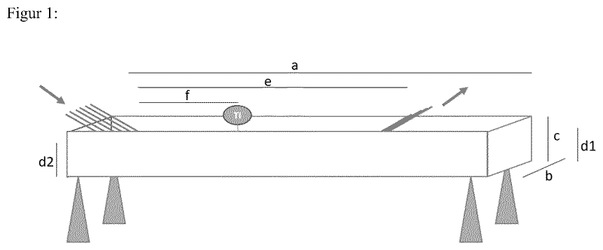

The resulting composition was pelletized by strand pelletizing. The cooling was effected in a spinning bath as per FIG. 1 without exchange of the water. The following meanings apply in FIG. 1:
a: Length of the bath 2460 mm
b: Width of the bath 295 mm
C: Height of the bath 165 mm
d: Water level 138 mm (average)
   d1: 125 mm; d2: 150 mm
e: Immersion length of the strands 1400 mm
f: Thermometer position 480 mm (after immersion length)
Number of strands: 6 Die plate: 6 hole 3.2 mm
Unit throughput: 50 kg/h
Strand speed: 20 m/min
Water volume in the spinning bath:

$$a \times b \times d = 2460 mm \times 295 mm \times 138 mm = 100.11$$

Amount in the test time:
Throughput kg/h×1 h/60 min×test duration min=50 kg/h×1/60 h/min×20 min=16.67 kg

Component PC-A1: Linear polycarbonate based on bisphenol A and phenol as chain terminator having a melt volume flow rate MVR of 9 cm³/(10 min) (to ISO 1133:2012-03, at a test temperature of 300° C. with a load of 1.2 kg). Contains low amounts of TPP.

Component PC-A2: Pulverulent linear polycarbonate based on bisphenol A and phenol as chain terminator having a melt volume flow rate MVR of 6 cm³/(10 min) (to ISO 1133:2012-03, at a test temperature of 300° C. with a load of 1.2 kg).

Component PC-A3: Pulverulent linear polycarbonate based on bisphenol A and phenol as chain terminator having a melt volume flow rate MVR of 19 cm³/(10 min) (to ISO 1133:2012-03, at a test temperature of 300° C. with a load of 1.2 kg).

Component PC-A4: Linear polycarbonate based on bisphenol A and phenol as chain terminator having a melt volume flow rate MVR of 9 cm³/(10 min) (to ISO 1133:2012-03, at a test temperature of 300° C. with a load of 1.2 kg). Contains no TPP.

Component PC-B: branched polycarbonate based on bisphenol A and 1,1,1-tri(4-hydroxyphenyl)ethane (THPE) as branching agent (1.3% by weight) and p-tert-butylphenol (BUP) as chain terminator having a melt volume flow rate MVR of 6 cm³/(10 min) (to ISO 1133:2012-03, at a test temperature of 300° C. with a load of 1.2 kg).

Component C₁: Potassium perfluorobutanesulfonate (also known as Rimar salt or C₄ salt) from. Lanxess AG, Germany.

Component D1: CS108F-14P chopped-strand non-binding glass fibres from 3B-Fibreglass sprl, Belgium.

Component D2: CS13720 chopped-strand non-binding glass fibres from 3B-Fibreglass sprl, Belgium.

Component E1: Octaphenylcyclotetrasiloxane (OPCTS) from Shin-Etsu Co, Ltd. Japan.

Component F1: Pentaerythritol tetrastearate (PETS, Loxiol P 861/3.5 Special) mould-release agent from Emery Oleochemicals GmbH Germany.

Component F2: MACROLEX YELLOW 3G GRAN yellow dye from Lanxess, Germany.

Component F3: COLORTHERM RED 130 M red dye from Lanxess, Germany.

Component F4: LAMP BLACK 101 carbon black black pigment from Evonik, Germany.

Component F5: KRONOS 2230 titanium dioxide white pigment from Kronos Titan GmbH, Germany.

Component F6: Triphenylphosphine (TPP) from BASF SE, Germany.

Component F7: Tinuvin 329 UV absorber from BASF SE, Germany.

Component F8: Disflamoll TOF (tris(isooctyl) phosphate) from Lanxess, Germany.

Component F9: Heucodur Yellow 3R yellow pigment from Heubach GmbH, Germany.

Component F10: Bayferrox 110 M iron oxide red pigment from Lanxess, Germany.

Melt volume-flow rate (MVR) was determined in accordance with ISO 1133:2012-03 (predominantly at a test temperature of 300° C., mass 1.2 kg) using a Zwick 4106 instrument from Zwick Roell. In addition, the MVR value was measured after a preheating time of 20 minutes (IMVR20′). This is a measure of melt stability under elevated thermal stress.

The fire performance was determined according to UL 94 V (50 W, 20 mm vertical). Pretreatment of the test bars:
2 days/23° C./50% rel. humidity
7 days/70° C./air circulation oven
Flame height: 20 mm
Flame application time: 2×10 s

The second flame application of the sample begins immediately after the end of the first afterflame time.

The following conditions apply for the UL94 5V fire performance:
500 W, 125 mm vertical

This method is used for ascertaining the flammability classes UL 94-5VA and -5VB.

The fire performance is assessed on bars and any potential hole formation is assessed on sheets.

### Pretreatment:

2 days/23° C./50% rel. humidity.
7 days/70° C./air circulation oven

The ash content was determined according to DIN 51903:2012-11 (850° C., hold for 30 min).

The proportion of component C was determined by means of DIN38407-42:2011-03. This means that the free perfluorobutanoic acid (C₄HF₇O₂) was determined. The free perfluoro acid was then enriched from the unfiltered water sample by solid-phase extraction on a polymer-based weak anion exchanger. The solid phases were washed with water and solvent and the adsorbed substance was then eluted with ammonia-containing methanol. Confirmation and quantitative determination were effected by high-performance liquid chromatography-mass spectrometry (HPLC-MS/MS).

TABLE 1

| Component | | C1 | I1 | I2 |
|---|---|---|---|---|
| PC-A1 (% by wt.) | | 78.404124 | 58.751219 | 57.763140 |
| PC-A2 (% by wt.) | | 9.880797 | 9.880797 | 9.880797 |
| PC-B (% by wt.) | | — | 19.761594 | 19.761593 |
| C (% by wt.) | | 0.197616 | 0.088927 | 0.088927 |
| D1 (% by wt.) | | 9.880797 | 9.880797 | 9.880797 |
| E1 (% by wt.) | | — | — | 0.988080 |
| F1 (% by wt.) | | 0.444636 | 0.444636 | 0.444636 |
| F2 (% by wt.) | | 0.000563 | 0.000563 | 0.000563 |
| F3 (% by wt.) | | 0.001502 | 0.001502 | 0.001502 |
| F4 (% by wt.) | | 0.004269 | 0.004269 | 0.004269 |
| F5 (% by wt.) | | 1.185696 | 1.185696 | 1.185696 |
| MVR (cm³/[10 min]) | 300° C.; 1.20 | 7.2 | 5.9 | 6.3 |
| | kg; 6 min | | | |
| MVR (cm³/[10 min]) | 300° C.; 1.20 | 7.8 | 6.1 | 6.9 |
| | kg; 19 min | | | |
| UL94-V | 1.80 mm | V-0 | V-0 | V-0 |
| 48 h/168 h | | V-0/V-0 | V-0/V-0 | V-0/V-0 |
| V0/V1/V2/failed (number) | | 10/0/0/0 | 10/0/0/0 | 10/0/0/0 |
| Afterflame time (s) | | N; 23/N; 25 | N; 20/N; 35 | N; 27/N; 31 |
| UL94-V | 1.50 mm | V-0 | V-0 | V-0 |
| 48 h/168 h | | V-0/V-0 | V-0/V-0 | V-0/V-0 |
| V0/V1/V2/failed (number) | | 10/0/0/0 | 10/0/0/0 | 10/0/0/0 |
| Afterflame time (s) | | N;23/N;32 | N;23/N;34 | N;25/N;35 |
| UL94-V | 1.20 mm | V-2 | V-2 | V-2 |
| 48 h/168 h | | V-2*/V-0 | V-2/V-2 | V-0/V-2 |
| V0/V1/V2/failed (number) | | 8/1/1/0 | 6/0/4/0 | 8/0/2/0 |
| Afterflame time (s) | | N; 40/N; 29 | N; 66/N; 44 | N; 28/N; 29 |
| UL94-5V | 3.00 mm | 5VA | 5VA | 5VA |
| Rating (bar) 48 h/168 h | | satisfied/satisfied | satisfied/satisfied | satisfied/satisfied |
| (sheet) 48 h/168 h | | satisfied/satisfied | satisfied/satisfied | satisfied/satisfied |
| Ash content (average) (ro) | 850.00000° C.; | 10.92 | 10.98 | 11.38 |
| (%) | 0.50000 h | | | |
| Perfluorobutanesulfonic | | | | |
| acid | | | | |
| Spinning water sample | μg/l | 149 | 32 | 16 |
| after test | | | | |
| Spinning water base value | μg/l | 3.2 | 8.1 | 7.5 |

*means second flame exposure, i.e. the sample was measured again.

TABLE 2

| Component | | C2 | I3 | I4 |
|---|---|---|---|---|
| PC-A1 (% by wt.) | | 68.562850 | 48.870422 | 47.882343 |
| PC-A2 (% by wt.) | | 9.880797 | 9.880797 | 9.880797 |
| PC-B (% by wt.) | | — | 19.761594 | 19.761593 |
| C (% by wt.) | | 0.158093 | 0.088927 | 0.088927 |
| D2 (% by wt.) | | 19.761594 | 19.761594 | 19.761594 |
| E1 (% by wt.) | | — | — | 0.988080 |
| F1 (% by wt.) | | 0.444636 | 0.444636 | 0.444636 |
| F2 (% by wt.) | | 0.000563 | 0.000563 | 0.000563 |
| F3 (% by wt.) | | 0.001502 | 0.001502 | 0.001502 |
| F4 (% by wt.) | | 0.004269 | 0.004269 | 0.004269 |
| F5 (% by wt.) | | 1.185696 | 1.185696 | 1.185696 |
| MVR (cm³/[10 min]) | 300° C.; 1.20 | 6.5 | 5.2 | 5.6 |
| | kg; 6 min | | | |
| MVR (cm³/[10 min]) | 300° C.; 1.20 | 7.1 | 6 | 6.3 |
| | kg; 19 min | | | |
| UL94-V | 1.80 mm | V-0 | V-0 | V-0 |
| 48h/168h | | V-0/V-0 | V-0/V-0 | V-0/V-0 |
| V0/V1/V2/failed | | 10/0/0/0 | 10/0/0/0 | 10/0/0/0 |
| (number) | | | | |
| Afterflame time (s) | | 27/20 | 20/29 | 18/29 |
| UL94-V | 1.50 mm | V-0 | V-0 | V-0 |
| 48h/168h | | V-0/V-0 | V-0/V-0 | V-0/V-0 |
| V0/V1/V2/failed | | 10/0/0/0 | 10/0/0/0 | 10/0/0/0 |
| (number) | | | | |
| Afterflame time (s) | | 30/30 | 23/32 | 25/35 |
| UL94-V | 1.20 mm | V-0 | V-0 | V-0 |
| 48h/168h | | V-0/V-0* | V-0/V-0 | V-0/V-0 |
| V0/V1/V2/failed | | 10/0/0/0 | 10/0/0/0 | 10/0/0/0 |
| (number) | | | | |
| Afterflame time (s) | | 31/26 | 32/32 | 33/39 |
| UL94-5V | 6.40 mm | | | |
| Rating (bar) 48h/168h | | at least 5-VB | at least 5-VB | at least 5-VB |
| Class bar test (ro) | | satisfied/satisfied | satisfied/satisfied | satisfied/satisfied |
| Ash content (average) | 850.00000° C.; | 20.63 | 20.81 | 20.88 |
| (ro) (%) | 0.50000 h | | | |
| Perfluorobutanesulfonic | | | | |
| acid | | | | |
| Spinning water sample | μg/l | 109 | 35 | 34 |
| after test | | | | |
| Spinning water base | μg/l | 6.4 | 15 | 4.4 |
| value | | | | |

TABLE 3

| Component | | C4 | I7 | 18 |
|---|---|---|---|---|
| PC-A4 (% by wt.) | | 89.253396 | 69.419309 | 69.419308 |
| PC-A3 (% by wt.) | | 9.103846 | 8.151810 | 9.143515 |
| PC-B (% by wt.) | | — | 19.834088 | 19.834088 |
| C (% by wt.) | | 0.128922 | 0.089253 | 0.089253 |
| E1 (% by wt.) | | — | 0.991704 | — |
| F1 (% by wt.) | | 0.396682 | 0.396682 | 0.396682 |
| F6 (% by wt.) | | 0.029751 | 0.029751 | 0.029751 |
| F7 (% by wt.) | | 0.247926 | 0.247926 | 0.247926 |
| F8 (% by wt.) | | 0.009917 | 0.009917 | 0.009917 |
| F9 (% by wt.) | | 0.166110 | 0.166110 | 0.166110 |
| F10 (% by wt.) | | 0.003967 | 0.003967 | 0.003967 |
| F4 (% by wt.) | | 0.109087 | 0.109087 | 0.109087 |
| F5 (% by wt.) | | 0.550396 | 0.550396 | 0.550396 |
| MVR (cm³/[10 min]) | 300° C.; 1.20 | 11.8 | 11.4 | 10.7 |
| | kg; 7 min | | | |
| MVR (cm³/[10 min]) | 300° C.; 1.20 | 12.7 | 12.5 | 11.8 |
| | kg; 20 min | | | |
| UL94-V | 3.00 mm | V-0 | V-0 | V-0 |
| 48 h/168 h | | V-0/V-0 | V-0/V-0 | V-0/V-0 |
| V0/V1/V2/failed (number) | | 10/0/0/0 | 10/0/0/0 | 10/0/0/0 |
| Afterflame time (s) | | N; 19/N; 35 | N; 23/N; 30 | N; 28/N; 25 |
| UL94-V | 2.80 mm | V-0 | V-0 | V-0 |
| 48 h/168 h | | V-0/V-0 | V-0/V-0 | V-0/V-0 |
| V0/V1/V2/failed (number) | | 10/0/0/0 | 10/0/0/0 | 10/0/0/0 |
| Afterflame time (s) | | N; 25/N; 25 | N; 27/N; 27 | N; 29/N; 28 |
| Perfluorobutanesulfonic acid | | | | |
| Spinning water sample after | μg/l | 100.0 | 26.0 | 13.0 |
| test | | | | |
| Spinning water base value | μg/l | 4.8 | 1.1 | 2.1 |

As can be gathered from Tables 1 to 3, when reducing the content of (C) in the composition the resulting content of (C) in the waste water decreases disproportionately when component (B) is present.

1. A method for reducing a content of a component (C), selected from the group of alkali metal, alkaline earth metal or ammonium salts of aliphatic or aromatic sulfonic acid, sulfonamide or sulfonimide derivatives and combinations thereof, in waste water obtained in the preparation of a composition, wherein the composition comprises
(A) linear polycarbonate and
(C) the compound selected from the group of alkali metal, alkaline earth metal or ammonium salts of aliphatic or aromatic sulfonic acid, sulfonamide or sulfonimide derivatives and combinations thereof,
wherein the composition additionally comprises
(B) a polycarbonate having a degree of branching of 0.8 to 1.5 mol %.

2. The method according to claim 1, wherein the method for preparing the composition comprises the following steps:
(a) compounding at least components (A) to (C) and
(b) pelletizing the compound obtained from step (a) in the presence of water.

3. The method according to claim 2, wherein in method step (b) the composition comes into contact with the water at least temporarily in the form of a melt.

4. The method according to claim 2, wherein the water present in method step (b) is obtained as waste water after performing method step (b).

5. The method according to claim 2, wherein the pelletizing in method step (b) is underwater pelletizing or strand pelletizing.

6. The method according to claim 1, wherein the composition comprises
(A) 4% to 85% by weight of linear polycarbonate,
(B) 14% to 95% by weight of polycarbonate having a degree of branching of 0.8 to 1.5 mol %,
(C) 0.040% to 0.095% by weight of the compound selected from the group of alkali metal, alkaline earth metal or ammonium salts of aliphatic or aromatic sulfonic acid, sulfonamide or sulfonimide derivatives and combinations thereof, and
(D) 0% to 40% by weight of a reinforcing fibre,
where the % by weight are based on a sum total of components (A) to (D).

7. The method according to claim 1, wherein the composition additionally comprises
(E) a cyclic siloxane of formula (R¹₂SiO)_{y} and/or a siloxane comprising a trifunctional siloxane unit of formula R²SiO_{3/2},
in which each R¹ independently is a monovalent aliphatic or aromatic hydrocarbon group or a fluorinated hydrocarbon group having in each case 1 to 18 carbon atoms and y is a number from 3 to 12 and
in which each R² independently is hydrogen, a monovalent aliphatic or aromatic hydrocarbon group having in each case 1 to 18 carbon atoms or a monovalent alkoxy group having 1 to 18 carbon atoms.

8. The method according to claim 1, wherein the composition additionally comprises
(F) at least one further additive selected from the group consisting of heat stabilizers, mould-release agents, UV absorbers, compatibilizers, antioxidants, IR absorbers, flow improvers, transesterification stabilizers, additives for laser marking, impact modifiers, light-scattering diffusion additives and colourants.

9. The method according to claim 8, wherein the composition consists of components (A) to (F).

10. A composition comprising a polycarbonate (B) having a degree of branching of 0.8 to 1.5 mol % for reducing a content of component (C) in waste water obtained in the preparation of the composition, wherein the composition comprises
(A) linear polycarbonate,
(B) the polycarbonate having a degree of branching of 0.8 to 1.5 mol % and
(C) a compound selected from the group of alkali metal, alkaline earth metal or ammonium salts of aliphatic or aromatic sulfonic acid, sulfonamide or sulfonimide derivatives and combinations thereof.

11. The composition according to claim 10, wherein the preparation of the composition comprises the following steps:
(a) compounding at least components (A) to (C) and
(b) pelletizing the compound obtained from step (a) in the presence of water.

12. The composition according to claim 11, wherein in method step (b) the composition comes into contact with the water characterize at least temporarily in the form of a melt.

13. The composition according to claim 11, wherein the water present in method step (b) is obtained as waste water after performing method step (b).

14. The composition according to claim 11, wherein the pelletizing in method step (b) is underwater pelletizing or strand pelletizing.

15. The composition according to claim 10, wherein the composition comprises
(A) 4% to 85% by weight of linear polycarbonate,
(B) 14% to 95% by weight of polycarbonate having a degree of branching of 0.8 to 1.5 mol %,
(C) 0.040% to 0.095% by weight of the compound selected from the group of alkali metal, alkaline earth metal or ammonium salts of aliphatic or aromatic sulfonic acid, sulfonamide or sulfonimide derivatives and combinations thereof, and
(D) 0% to 40% by weight of a reinforcing fibre,
where the % by weight are based on a sum total of components (A) to (D).
